(19) United States
(12) Patent Application Publication
(10) Pub. No.: US 2026/0155561 A1
(43) Pub. Date: Jun. 4, 2026

(54) LIGHTING MODULE HAVING A FLEXIBLE GUIDE SHEET WITH INTEGRATED ANTENNA

(71) Applicant: VALEO VISION, Bobigny (FR)

(72) Inventor: Eduardo ALVEAR CABEZON, Bobigny (FR)

(73) Assignee: VALEO VISION, Bobigny (FR)

(21) Appl. No.: 19/108,780

(22) PCT Filed: Aug. 8, 2023
(86) PCT No.: PCT/EP2023/071958

§ 371 Date: Feb. 10, 2026

(30) Foreign Application Priority Data
Sep. 9, 2022 (FR) FR2209076

(51) Int. Cl. H01Q 1/40; F21S 41/24; F21V 8/00; H01Q 9/04

(52) U.S. Cl. CPC H01Q 1/40; G02B 6/0035; G02B 6/0065; H01Q 9/0407; F21S 41/24

(57) ABSTRACT

The invention relates to a lighting module including an assembly of at least one flexible guide sheet, each flexible guide sheet being able to return light rays in a direction substantially normal to a surface of the flexible guide sheet according to at least one pattern etched in the flexible guide sheet. The lighting module also includes at least one light-injection element capable of receiving light and of distributing light in the assembly of at least one flexible guide sheet, and at least one light source capable of injecting light into the at least one light-injection element. The lighting module further includes a metal nanometric mesh forming an antenna is deposited on at least one surface of at least one flexible guide sheet of the assembly.

The present invention relates to the field of luminous modules, notably light guidance luminous modules. The invention particularly, but not exclusively, applies to the display of light patterns.

Many devices are integrating more and more lighting functions, notably in order to convey information, for esthetic customization purposes or to create ambiance.

It is also a requirement for light patterns to be displayed with a high resolution level.

To this end, it is known practice to use screens, such as LCD screens.

However, this technology is not only expensive but also sensitive to environmental conditions, such as temperature, humidity or UV radiation.

Moreover, having a flexible luminous module is preferable for facilitating its integration into any type of device.

However, many devices also require numerous functions, notably telecommunications and/or detection functions. Providing a dedicated module for each of these functions results in systems that are both expensive and bulky.

Therefore, a requirement exists to provide a luminous module that is able to display a light pattern while being reliable, inexpensive and easy to integrate in any type of device, and is also able to fulfill a telecommunications and/or detection function.

The present invention improves the situation.

To this end, a first aspect relates to a luminous module comprising:
an assembly of at least one flexible guide sheet, with each flexible guide sheet of the assembly being able to receive light rays via at least one edge of said flexible guide sheet and to reflect the light rays in a direction substantially normal to a surface of the flexible guide sheet according to at least one pattern etched into said flexible guide sheet, wherein the assembly is able to reflect light according to at least one pattern etched into said assembly;
at least one light injection element able to receive light and to distribute the light in the assembly of at least one flexible guide sheet;
at least one light source able to inject light into said at least one light injection element;
a metal nanometric mesh forming an antenna and arranged on at least one surface of at least one flexible guide sheet of the assembly.

Thus, the luminous module according to the invention allows both a light function and a function using an antenna to be fulfilled, such as a detection and/or telecommunications function, while being easy to integrate in any type of device since it is in the form of a flexible sheet. Furthermore, the use of a flexible guide sheet allows a light pattern to be displayed over a significant surface area. Moreover, the light function is not degraded by the antenna because it is in the form of a nanometric mesh, and is therefore invisible to the naked eye, irrespective of the surface of the luminous module on which it is arranged.

According to some embodiments, the metal nanometric mesh can comprise metal strips that are less than 100 nanometers wide.

Thus, the antenna is indistinguishable to the naked eye, thereby not affecting the light function fulfilled by the luminous module.

According to some embodiments, the module can further comprise a device connected to the metal nanometric mesh and able to transmit and/or receive radio frequency signals via said metal nanometric mesh.

Thus, the luminous module is able to fulfill a detection and/or telecommunications function, using an antenna integrated with the light function. Such a luminous module thus can be integrated into devices with significant spatial requirement constraints.

According to one embodiment, the device can be a radar.

Such an embodiment is particularly advantageous in automotive vehicles, where more and more radar-type detection systems are used, notably in order to provide input data for driver assistance functions.

As a variant, the device can be a cellular telecommunications transceiver.

Such a variant is advantageous when the luminous module is integrated in a device requiring a telecommunications function.

According to some embodiments, each flexible guide sheet can comprise a flexible film with a pattern etched thereon, and at least one protective layer covering said flexible film, with said metal nanometric mesh being arranged on a surface of said protective layer of at least one flexible guide sheet.

Thus, the protective layer fulfills both a function of protecting the flexible film and of supporting the antenna, thereby improving the service life of the luminous module without reducing the compactness thereof.

Additionally, the protective layer on which the metal nanometric mesh is arranged can be arranged so as to be traversed by light rays emitted by the flexible film.

Thus, the antenna is arranged toward the outside of the luminous module, and therefore toward the outside of a device in which the luminous module would be arranged, which improves its efficiency. Insofar as the antenna comprises a nanometric mesh, it does not affect the display of the light pattern.

Also additionally, the metal nanometric mesh can be arranged on an external surface of the protective layer, so that the protective layer is included between the flexible film and the metal nanometric mesh.

Thus, the efficiency of the antenna is maximized.

According to some embodiments, the luminous module can comprise at least one first light injection element and one second light injection element, the at least one light source may be able to selectively inject light into the first light injection element and into the second light injection element, and at least one first pattern and one second pattern are etched into the assembly of at least one flexible guide sheet. The first light injection element and the assembly of at least one flexible guide sheet can be arranged so as to project light according to the first pattern and wherein the second light injection element and the assembly of at least one flexible guide sheet can be arranged so as to project light according to the second pattern.

It is thus possible to display complex patterns, possibly over large surface areas.

Additionally, the luminous module can comprise a first light source able to inject light into the first light injection element and a second light source able to inject light into the second light injection element.

Providing one light source per injection element facilitates the control of the selective injection of light into the first and second injection elements.

Additionally or as a variant, the first injection element can be arranged so as to inject light into a first section of the edge of the guide sheet of the assembly, and the second injection element can be arranged so as to inject light into a second section of the edge of the flexible guide sheet, with a first portion of the flexible guide sheet located facing the first section of the edge being etched according to the first pattern, and a second portion of the flexible guide sheet located facing the second section of the edge being etched according to the second pattern.

Thus, several patterns can be selectively displayed on the same flexible guide sheet.

As a variant, the assembly comprises at least one first and one second flexible guide sheet, with the first pattern being etched into the first flexible guide sheet and the second pattern being etched into the second flexible guide sheet, the first injection element being arranged so as to inject light into an edge of the first flexible guide sheet and the second injection element being arranged so as to inject light into an edge of the second flexible guide sheet.

In these embodiments, a pattern is etched into each flexible guide sheet, which allows the patterns to be multiplied, without reducing their size, in the form of an equal flexible guide sheet.

Additionally, the first and second guide sheets can be overlaid in the luminous module, in order to project the first and second patterns into a common area of the luminous module.

It is thus possible to produce an animation by varying a pattern in the common area.

As a variant, the first and second flexible guide sheets can be placed next to each other so as to project the first and second patterns at distinct positions.

It is thus possible to produce animations with spatial movement of a pattern, or to project several patterns at a time, which increases the number of combinations of patterns that is possible for a given number of flexible guide sheets.

According to some embodiments, the luminous module can further comprise a control element able to control said at least one source in order to selectively project light according to said at least one pattern.

Thus, a single element is able to selectively control the injection of light into one or more light injection elements of the luminous module, which improves the synchronization for displaying one or more luminous patterns relative to one another.

According to some embodiments, each flexible guide sheet of the assembly can comprise a polycarbonate (PC), polymethyl methacrylate (PMMA), thermoplastic polyurethane (TUP) or polyethylene terephthalate (PET) film.

Such materials allow a transparent and flexible guide sheet to be produced.

According to some embodiments, each flexible guide sheet can comprise a film comprising microstructures, in which each pattern from among the first and second patterns is etched by ultraviolet printing the microstructures of the film.

Such microstructures allow patterns to be produced with good resolution, while maintaining a high level of transparency for the flexible guide sheet.

A second aspect of the invention relates to an external device for an automotive vehicle, comprising a luminous module according to the first aspect of the invention.

According to some embodiments, the device can be a front lighting device for an automotive vehicle.

Additionally or as a variant, the external device can further comprise a sensor able to detect a signal from an electromagnetic wave repeated or amplified by the metal nanometric mesh.

Thus, the luminous module can also fulfill the function of repeating a signal so as to facilitate its detection.

A third aspect of the invention relates to a method for manufacturing a luminous module comprising the following steps of:
providing a roll of flexible film able to guide light in the thickness thereof;
etching at least one pattern onto said roll of flexible film using ultra-violet printing;
cutting said roll in order to obtain at least one flexible film with a given dimension, with the flexible film comprising said etched pattern;
obtaining a metal nanometric mesh forming an antenna;
arranging said metal nanometric mesh on the flexible film so as to form an assembly of at least one flexible guide sheet;
arranging at least one injection element relative to the assembly of at least one flexible guide sheet in order to form a luminous module;
arranging at least one light source in the luminous module so as to inject light into said at least one light injection element.

According to some embodiments, obtaining the metal nanometric mesh forming an antenna comprises the following steps of:
providing a roll of substrate;
cutting a portion of the roll of substrate;
producing the metal nanometric mesh on the cut portion or on the roll of substrate before cutting the portion.

The metal nanometric mesh can be arranged on the flexible film by depositing the cut portion with the metal nanometric mesh in order to form a protective layer for the etched flexible film.

Additionally, the metal nanometric mesh can be produced on the cut portion using lithography, or on the roll of substrate before cutting, by placing a mask matching the mesh on the cut portion of the roll.

Further features and advantages of the invention will become apparent with reference to the following detailed description, and the appended drawings, in which:

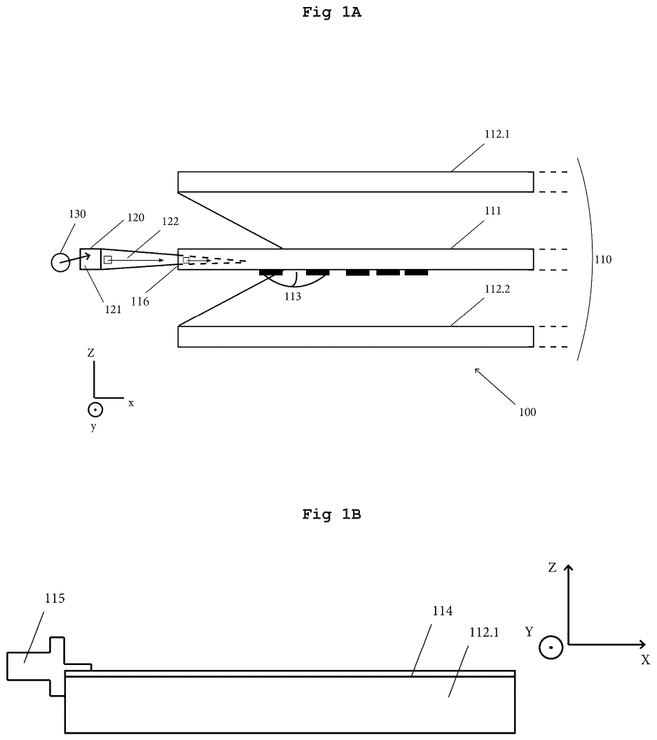

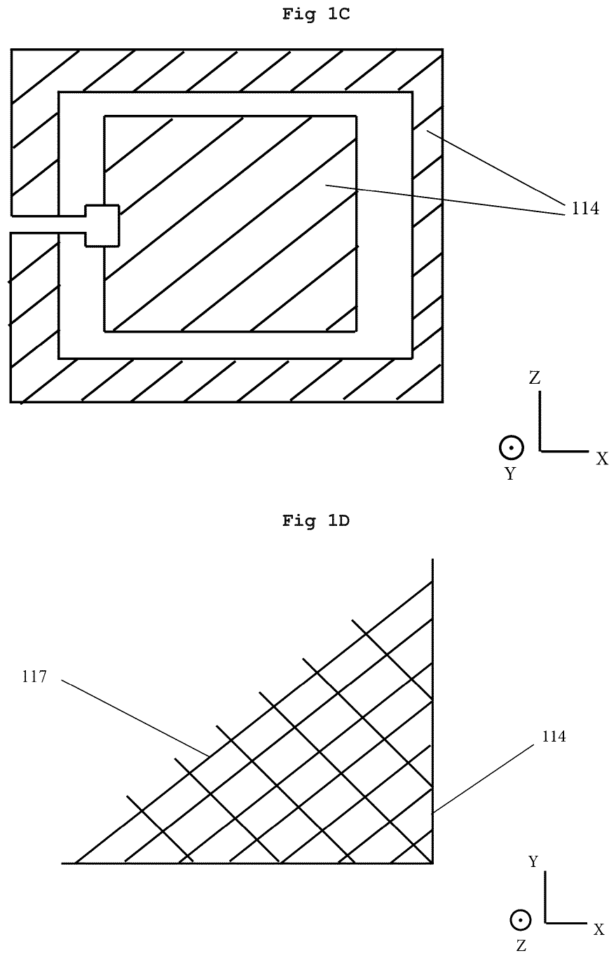

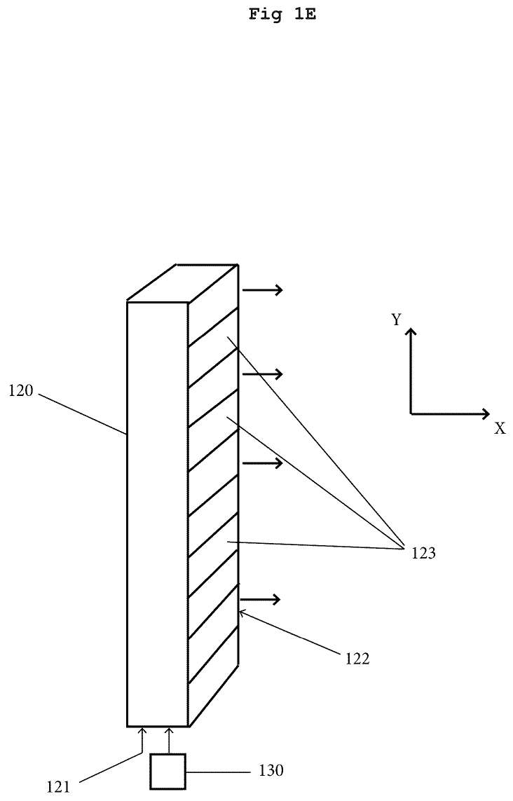

FIG. 1a illustrates a luminous module according to some embodiments of the invention;

FIG. 1b illustrates a side view of a protective layer of a luminous module according to some embodiments of the invention;

FIG. 1c illustrates a front view of a metal nanometric mesh on a protective layer of a luminous module according to some embodiments of the invention;

FIG. 1d illustrates an exploded view of a metal nanometric mesh forming an antenna for a luminous module according to some embodiments of the invention;

FIG. 1e illustrates an injection element of a luminous module according to one embodiment of the invention;

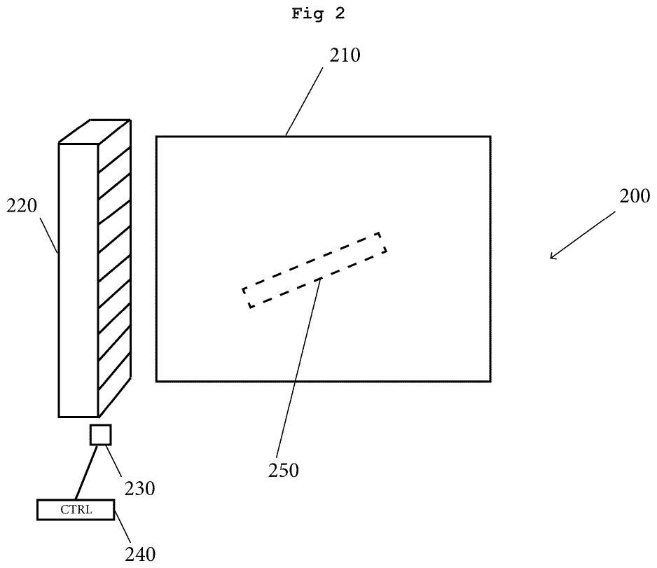

FIG. 2 illustrates a luminous module according to a first embodiment of the invention;

FIG. 3 illustrates a luminous module according to a second embodiment of the invention;

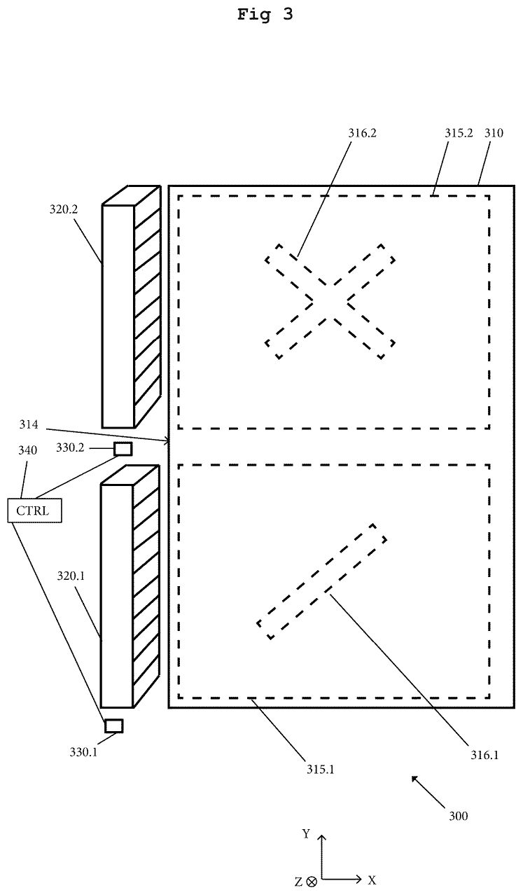

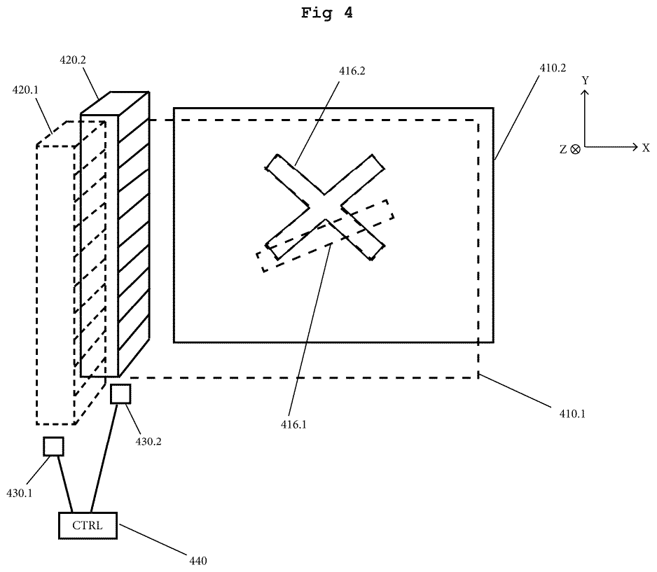

FIG. 4 illustrates a luminous module according to a third embodiment of the invention;

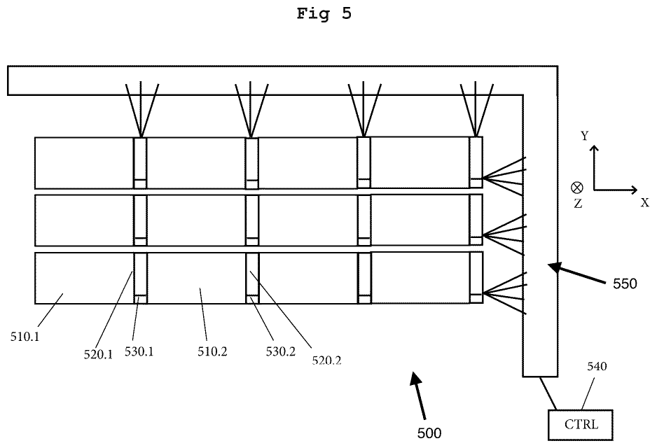

FIG. 5 illustrates a luminous module according to a fourth embodiment of the invention;

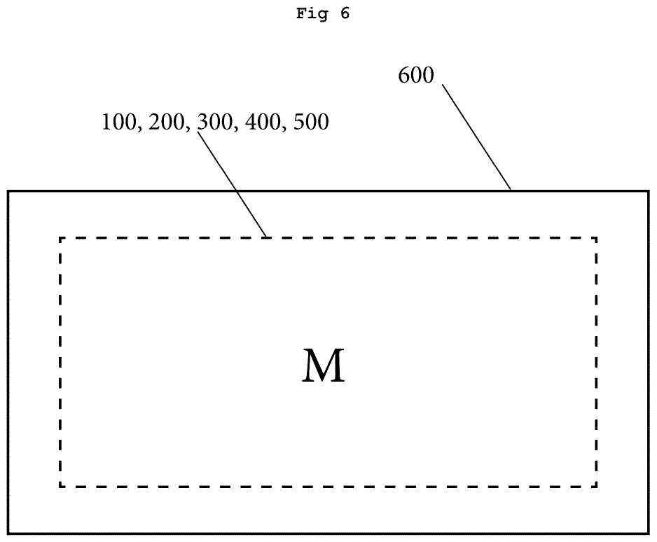

FIG. 6 illustrates a device comprising a luminous module according to some embodiments of the invention;

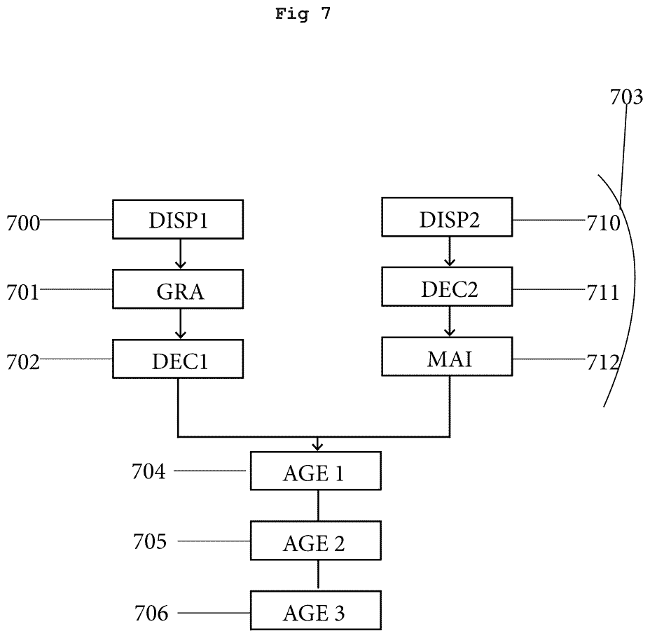

FIG. 7 is a diagram illustrating the steps of a method for manufacturing a luminous module according to one embodiment of the invention.

The description concentrates on the features that differentiate the methods or the luminous module from those known in the prior art.

FIG. 1a shows a luminous module 100 according to some embodiments of the invention.

The luminous module 100 comprises a flexible guide sheet 110 able to receive light rays via an edge 116 and to reflect the light rays in a direction Z substantially normal to a surface of the flexible guide sheet, which thus extends in an X-Y plane in FIG. 1a.

A guide sheet is understood to mean an optical guide element, one of the dimensions of which is much smaller than the other two dimensions in space, for example, less than one or more orders of magnitude. As illustrated in FIG. 1, a flexible guide sheet is considered herein, the thickness of which along the Z-axis is lower by at least two orders of magnitude than its dimensions along the X-Y plane in which the flexible guide sheet 110 extends.

The flexible guide sheet 110 can include a flexible film 111 at its core comprising at least one edge 116, which is able to guide the light rays in an overall direction X, and comprising a set of microstructures 113 able to reflect the light rays guided in the flexible film 111 outside the flexible guide sheet 110, notably in one or more directions substantially along the Z-axis.

The flexible film 111 can be a substrate film made of polycarbonate (PC), polymethyl methacrylate (PMMA), thermoplastic polyurethane (TUP) or polyethylene terephthalate (PET). The thickness, i.e., a dimension along the Z-axis, of the flexible film 111 can range between 12 and 1,000 micrometers. More specifically, the thickness of the flexible film 111 can range between 50 and 1,000 micrometers, for example, between 200 and 500 micrometers. As a variant, it is the thickness of the flexible guide sheet 110 that ranges between 200 and 1,000 micrometers.

The aforementioned materials, associated with a limited thickness, as described above, allow a flexible film 111 to be obtained. Other materials can be considered for the composition of the flexible film 111. However, it is preferable, according to the invention, to provide deformable and transparent materials.

A thin coating of microstructures 113 can be applied to one of the faces of the flexible film 111, or can be integrated in the flexible film 111. The thickness of the coating of microstructures 113 along the Z-axis notably can be less than 20 micrometers.

Such microstructures 113 can assume the general shape of a bump, on which the light rays are reflected in a direction substantially along the Z-axis. Such microstructures 113 may allow the light rays exiting the flexible film 111 to form a pattern. To this end, the microstructures 113 can be etched by ultraviolet printing, according to the desired pattern.

Microstructures 113 are understood to mean structures, or irregularities in the flexible film, with dimensions that are less than a few micrometers. The microstructures thus also cover nanometric structures. Such sizes of microstructures 113 ensure high transparency of the flexible film 111. In particular, transparency of the order of 97% can be obtained in practice by the use of microstructures 113. As a variant, the flexible guide sheet can be semi-transparent or opaque.

Advantageously, the microstructures 113 can be distributed along the X-axis such that a linear density of microstructures 113 is proportional to the distance from the edge 116 through which the light rays injected by the injection element 120 are received. In other words, the farther the microstructures 113 are from the edge 116, the more densely they are grouped together. Such a distribution advantageously ensures homogeneous distribution, along the X-axis, of the light intensity of the pattern emitted by the flexible guide sheet 110.

The flexible guide sheet 110 can further comprise one or two protective layers 112.1 and 112.2, which allow the flexible film 111 to be encapsulated and mechanically protected. Furthermore, one of the protective layers 112.1 and 112.2 at least can optionally include an anti-UV treatment, for protecting the flexible film against UV rays, once the microstructures 113 have been etched. Without such UV protection, the pattern projected by the flexible guide sheet 110 is likely to degrade over time, especially when it is exposed to rays from the sun.

The flexible film 111 and the protective layers 112.1 and 112.2 are shown spaced apart in FIG. 1a, purely for illustrative purposes. However, it will be understood that the protective layers 112.1 and 112.2 can be joined to the flexible film, notably by rolling. The luminous module 100 can comprise only one of the protective layers 112.1 and 112.2 shown in FIG. 1a.

According to the invention, at least one of the protective layers 112.1 and 112.2 comprises a metal nanometric mesh 114 forming an antenna. Such an antenna in an X-Y plane is also called patch antenna. Such an antenna can form part of a wireless telecommunications device, such as a cellular transceiver, for example, 3G, 4G, 5G, or any next generation, or can form part of a detection device, such as a radar.

Such a metal nanometric mesh 114 is invisible to the naked eye, which allows the protective layer 112.1 or 112.2 on which the mesh is deposited to be transparent. As shown in FIG. 1a, the mesh 114 can be arranged on the protective layer 112.1 that is traversed by the light rays reflected by the flexible film 111.

The transparency rate of the protective layer covered with the mesh 114 can be of the order of 98%.

Thus, when the mesh is disposed on the protective layer 112.1, the antenna function is maximized, since the protective layer 112.1 is oriented toward the outside of the luminous module 100, yet without degrading the light function fulfilled by the flexible film 111 that illuminates according to a given pattern. The mesh 114 can be arranged on an internal surface of the protective layer 112.1, either between the protective layer 112.1 and the flexible film 111, or can be arranged on an external surface of the protective layer 112.1, as shown in FIG. 1a. Similarly, as a variant, the mesh 114 can be arranged on an internal surface of the protective layer 112.2, either between the protective layer 112.2 and the flexible film 111, or can be arranged on an external surface of the protective layer 112.2.

Like the flexible film 111, the protective layer comprising the mesh 114 can be flexible, and thus can be made of a material such as PMMA, PET, PC. For example, the protective layer can be made of the same material as the flexible film 111. As a variant, the material of the protective layer can be rigid and can be any plastic or glass-based material.

According to some embodiments, the antenna formed by the mesh 114 may be able to transmit and/or receive radio frequency signals with frequencies ranging between 1 MHz and 100 GHz, for example, ranging between 400 MHz and 92 GHZ.

The mesh 114 can also fulfill a defrosting function, by circulating an electric current through the mesh 114, which is particularly advantageous when the luminous module is exposed to varying weather conditions, notably when the luminous module is installed in a device for an automotive vehicle, such as a lighting device.

With the guide sheet 110 being flexible, it is not necessarily included in a plane but can be curved, depending on the position it is placed in and the mechanical stresses applied thereto.

The portion of the luminous module 100 illustrated in FIG. 1a also comprises a light injection element 120, also referred to as a light bar, because it extends longitudinally in a direction Y, and is able to inject light in a direction normal to its longitudinal direction, for example, along the X axis when it is arranged in the manner shown in FIG. 1a.

The light injection element 120 has a rectangular or square section in FIG. 1a. However, the light injection element 120 can have a round, oval, or polygonal section.

Thus, the light injection element 120 comprises an exit surface 122 extending in the longitudinal direction and able to inject light in a direction substantially normal to the exit surface 122. The light injection element 120 further comprises an entry surface 121, at one end of the light injection element 120, able to receive light rays from a light source 130, and the light injection element 120 is able to longitudinally guide the light along the Y-axis by distributing it over the exit surface 122. The light distribution via the exit surface 122 will be better understood in the light of the description of FIG. 2.

No restriction is imposed on the light source 130. It may be, for example, a light-emitting source of the LED type, for example, having the advantage of being small, having low energy consumption and having low heat build-up. The light source 130 may be able to generate light in a wavelength range. Such a range can be centered around a visible color, in order to generate colored light, for example, blue, red or green. As a variant, the light source 130 can emit light rays across the entire range of wavelengths visible to the human eye, so as to generate white light. A very narrow wavelength range can be produced by a laser type light source 130.

As a variant, the light source 130 is not arranged directly facing the entry surface 121 of the injection element 120, but the luminous module 100 further comprises an optical fiber placed between the source 130 and the injection element 120, thereby moving the source 130 relative to the assembly formed by the injection element 120 and the flexible guide sheet 110.

FIG. 1b shows a side view, in an X-Z plane of the protective layer 112.1 covered with a metal nanometric mesh 114, of a luminous module according to some embodiments of the invention.

The thickness, i.e., a dimension along the Z-axis, of the protective layer 112.1 can be of the order of a millimeter, for example, ranging between 0.5 and 2 mm, notably equal to 1.1 mm.

The thickness of the mesh 114 along the Z-axis can be of the order of a micron, for example, ranging between 1 and 5 microns, notably equal to 3 microns.

No restriction is imposed on the metal of the mesh 114, which can be copper, silver, platinum, aluminum or nickel.

The luminous module 100 can further comprise a device 115 able to receive and/or transmit signals via the antenna formed by the mesh 114. The device 115 can be, for example, a radar or a telecommunications transceiver, for example, a cellular transceiver. As a variant, the device 115 is an interface between the mesh 114 and a module able to receive and/or transmit signals via the antenna, and not shown in FIG. 1b.

FIG. 1c shows a top view, in an X-Z plane of the metal nanometric mesh 114 covering a protective film 112.1, of a luminous module according to some embodiments of the invention.

The mesh 114 is thus distributed over the hatched surface shown in FIG. 1c. Thus, the entire hatched surface is not covered with metal, but is covered with metal nanometric strips, or more generally with metal patterns with nanometric dimensions, such that the metal mesh 114 forms a nanogrid that is not visible to the naked eye. Thus, when the substrate on which the mesh 114 is deposited is transparent, as is the case for the protective layer 112.1, it is possible to see through the substrate covered with the mesh 114.

The surface covered by the mesh 114 can be of the order of several tens of millimeters, for example, of the order of 300 mm. By way of an example, the external surface shown in FIG. 1c can be a 300 mm-sided square. However, no restriction is imposed on the dimensions or the shape of the surface covered by the mesh 114 according to the invention. The geometry of the antenna thus formed by the metal mesh is related to the value of the detection frequency. Indeed, if the detection frequencies are within a range of the order of GigaHertz, GHz, the dimension of the formed antenna is approximately 300 mm. In a range in the field of TeraHertz, THz, the dimension of the antenna is less than a few micrometers, with 1 THz corresponding to a wavelength of 333 micrometers.

FIG. 1d shows an exploded, or zoomed view, with respect to the previous figures, of the mesh 114, so as to distinguish the nanometric metal strips 116 that form the mesh 114. The strips 116 can have a nanometric width, for example, equal to a few tens of nanometers, notably equal to 50 nanometers. The strips 116 can be made by etching metal base patterns with nanometric dimensions side by side. Another function that may be allowed by such a metal nanometric mesh is to promote the transmission of waves ahead of the luminous module, which means that the mesh functions as a signal amplifier or repeater. It can thus promote the reception of a signal by another sensor integrated in a device comprising the luminous module or in a device in the vicinity of the luminous module, such as a vehicle headlamp.

FIG. 1e shows an injection element 120 of a luminous module 100 according to one embodiment of the invention.

The injection element 120 can comprise a plurality of injection guides 123 able to receive light from the source 130 via the entry surface 121 and to guide the light to a longitudinal position of the exit surface 122, with the longitudinal positions of the light guides being distinct so as to distribute the light to at least several longitudinal positions of the exit surface 122.

This allows light to be injected at different longitudinal positions along the Y axis on the edge 116. Each longitudinal position of the edge 116 can correspond to a guide line of the flexible film 111, able to guide the light along the X-axis along such a guide line.

Such an association of a flexible guide sheet 110, an injection element 120 and a source 130 thus allows light to be projected in the Z direction via a flexible, transparent, semi-transparent or opaque surface, with good surface homogeneity and according to a given pattern.

In practice, such a luminous module can allow a pattern to be emitted with brightness ranging between 100 and 1,000 Candela per square meter, with a light extraction efficiency that can vary between 25% and 80%.

Details concerning the structure and the arrangement of these elements 110, 120 and 130 are described further in the international patent application published under number WO2011/130715A2 .

Thus, a luminous module according to the invention comprises:
an assembly of at least one guide sheet, such as the flexible guide sheet 110 illustrated in FIG. 1a, with the assembly being able to reflect light according to at least one pattern;
at least one light injection element able to be the injection element 120 described with reference to FIGS. 1a and 1b; and
at least one light source, such as the light source 130 described above with reference to FIG. 1a, able to selectively inject light into said at least one injection element;
a metal nanometric mesh forming an antenna, such as the mesh 114 at least partially arranged on a surface of a flexible guide sheet 110.

Thus, such a luminous module 100 can be easily integrated into any type of device, including in automotive devices comprising non-planar and difficult to access surfaces, while further performing an antenna function without degrading the pattern displayed by the flexible guide sheet. The compactness associated with the device in which the luminous module 100 is integrated is thus improved. The signaling and telecommunications modules are currently difficult to install in the same space due to the required amount of cables. The luminous module 100 according to the invention thus allows compactness to be significantly increased.

“Pattern” is understood to mean any predefined spatial distribution of the luminous intensity emitted by the luminous module. In particular, reference is made herein to a two-dimensional or one-dimensional pattern. A pattern thus may be a two-dimensional shape or symbol obtained by contrasting between the luminous intensities of various positions in the X-Y plane of the flexible guide sheet 110. The pattern may also comprise a plurality of shapes or symbols. Alternatively, a pattern covers a predefined, or intentional, spatial distribution of luminous intensity that does not cause any general shape to appear, such as a distribution resulting in a cloud of luminous dots. Within the context of the present invention, a pattern is formed by injecting light into an injection element that is arranged relative to a flexible guide sheet so as to form the pattern on the flexible guide sheet.

Particular embodiments of the invention are described hereafter.

FIG. 2 illustrates a luminous module 200 according to a first embodiment of the invention.

The luminous module 200 comprises a flexible guide sheet 210, an injection element 220 and a light source 230, similar to the flexible guide sheet 110, the injection element 120 and the light source 130 described above with reference to FIGS. 1a and 1b. Thus, the flexible guide sheet 210 comprises a mesh 114 as described above, although it is not shown in FIG. 2.

The flexible guide sheet 210 is etched according to a pattern 250 comprising a rectangular luminous area, able to reflect the light rays injected by the injection element 220, following the activation of the light source 230. No restriction is imposed on the geometry of the pattern 250, which is more generally as previously defined.

According to some embodiments, the luminous area can be arranged facing an optical projection surface of a lighting device, in the case whereby the luminous module is integrated in such a lighting device, notably for an automotive vehicle. The luminous area also can be shaped so as to be overlaid with the optical projection surface of the lighting device.

Advantageously, the light source 430 is controlled by a control element 240. It is thus possible to activate or deactivate the light source 230 so as to control the display of the pattern 250.

Thus, in the first embodiment, the luminous module comprises a single flexible guide sheet, a single injection element and a single light source.

FIG. 3 illustrates a luminous module 300 according to a second embodiment of the invention.

In the second embodiment, several injection elements are arranged in order to inject light into the same flexible guide sheet, comprising several patterns.

In particular, in the example of FIG. 3, a first injection element 320.1 and a second injection element 320.2 are arranged so as to inject light into an edge 314 of a flexible guide sheet 310.

The first and second injection elements 320.1 and 320.2 can be similar to the injection element 120 described with reference to FIGS. 1a and 1b. Similarly, the flexible guide sheet 310 can correspond to the flexible guide sheet 110 described above. Thus, the flexible guide sheet 310 comprises a mesh 114 as described above, although it is not shown in FIG. 3.

As shown in FIG. 3, the first injection element 320.1 and the second injection element 320.2 are arranged so as to inject light into the edge 314, at distinct longitudinal positions, along the Y axis.

It should be noted that, because it is flexible, the guide sheet 310 may not be flat but may be curved. FIG. 3 thus shows the luminous module 300 when the guide sheet is flat, for example, placed on a flat rigid support.

The first injection element 320.1 is thus able to inject light into the edge 314, which light is then guided by the flexible guide sheet 310 into a first portion 315.1 of the flexible guide sheet 310. The second injection element 320.2 is able to inject light into the edge 314, which is then guided into a second portion 315.2 of the flexible guide sheet 310.

To this end, a first source 330.1 is arranged facing an entry surface of the first injection element 320.1 so as to propagate light rays inside the first injection element 320.1 and therefore toward the first portion 315.1 of the flexible guide sheet 310. A second source 330.2 is arranged facing an entry surface of the second injection element 320.2 so as to propagate light rays inside the second injection element 320.2 and therefore toward the second portion 315.2 of the flexible guide sheet 310.

As a variant, a single source can be provided and the luminous module 300 comprises a first optical fiber able to convey light from the single source to the entry surface of the first injection element 320.1 and a second optical fiber is able to convey light from the single source to the entry surface of the second injection element 320.2.

The first and second sources 330.1 and 330.2, or the single source, can selectively inject into the first injection element 320.1 and/or into the second injection element 320.2. Such selective injection can be controlled by a control element 340 connected to the two sources 330.1 and 330.2, or controlling the power supply to the two sources 330.1 and 330.2.

A first pattern 316.1 is etched into the first portion 315.1, while a second pattern 316.2 is etched into the second portion 315.2. The selective injection of light into the first injection element 320.1 and/or into the second injection element 320.2 thus allows projection of the first pattern, the second pattern, neither of the patterns or both patterns at the same time, thus allowing, by dynamic control, an animation to be produced from at least the first and second patterns.

In the example of FIG. 3, the first and second patterns 316.1 and 316.2 have distinct shapes. However, according to the definition of pattern provided above, the patterns may be any intentional, or predetermined, spatial variation of luminous intensity. Furthermore, when the patterns are shapes, the first and second patterns 316.1 and 316.2 may have identical shapes. Animation is then enabled by the spatial movement of the pattern from the first portion 315.1 to the second portion 315.2, or vice versa. Furthermore, the colors respectively projected for each pattern can vary, when the sources 330.1 and 330.2 produce light of different colors.

An example with two patterns and two injection elements has been shown in FIG. 3. However, the second embodiment also covers a luminous module with a flexible guide sheet with three or more portions, with each portion comprising an etched pattern, and with at least three injection elements, with each injection element being placed facing one of the portions.

Dedicated sources for each injection element can be provided to this end, or a single source with several optical fibers can be provided to this end.

FIG. 4 illustrates a luminous module 400 according to a third embodiment of the invention.

In the third embodiment of the invention, the luminous module 400 comprises at least one first flexible guide sheet 410.1 and one second flexible guide sheet 410.2, with the two flexible guide sheets being overlaid, which implies that at least one portion of the first flexible guide sheet 410.1, in the X-Y plane, is overlaid with at least one portion of the second flexible guide sheet 410.2, in a common area, which corresponds to a set of positions in the X-Y plane.

Preferably, the first and second flexible guide sheets 410.1 and 410.2 have the same dimensions in the X-Y plane, and are fully overlaid.

It should be noted that, due to their flexibility, the guide sheets may not be flat but may be curved. FIG. 4 thus shows the luminous module 400 when the guide sheets are flat, for example, stacked on a flat support.

Such overlaying is notably advantageous because the flexible guide sheets are preferably transparent, as described above.

Thus, the first and second flexible guide sheets 410.1 and 410.2 are able to project a first pattern 416.1 and a second pattern 416.2, respectively, into a common area.

A first injection element 420.1 is arranged to inject light into an edge of the first flexible guide sheet 410.1 and a second injection element 420.2 is able and arranged to inject light into an edge of the second guide sheet 410.2.

The first and second injection elements 420.1 and 420.2 can be similar to the injection element 120 described with reference to FIGS. 1a and 1b. Similarly, at least one of the flexible guide sheets 410.1 and 410.2 can correspond to the flexible guide sheet 110 described above. Preferably, only one of the flexible guide sheets 410.1 and 410.2 comprises a mesh 114 forming an antenna as described above, although it is not shown in FIG. 3. Preferably, the flexible guide sheet located above, that is, toward the outside of the luminous module, comprises the mesh 114, i.e., the second flexible guide sheet 410.2. Thus, the function of receiving/transmitting signals by the antenna formed by the mesh 114 is optimized.

A first source 430.1 is arranged facing an entry surface of the first injection element 420.1 so as to propagate light rays inside the first injection element 420.1 and therefore toward the first flexible guide sheet 410.1. A second source 430.2 is arranged facing an entry surface of the second injection element 420.2 so as to propagate light rays inside the second injection element 420.2 and therefore toward the second flexible guide sheet 410.2.

As a variant, a single source can be provided and the luminous module comprises a first optical fiber able to convey light from the single source to the entry surface of the first injection element 420.1 and a second optical fiber is able to convey light from the single source to the entry surface of the second injection element 420.2.

The first and second sources 430.1 and 430.2, or the single source, can selectively inject into the first injection element 420.1 and/or into the second injection element 420.2. Such selective injection can be controlled by a control element 440 connected to the two sources 430.1 and 430.2, or controlling the power supply to the two sources 430.1 and 430.2.

The first pattern 416.1 is etched into the first flexible guide sheet 410.1, while the second pattern 416.2 is etched into the second flexible guide sheet 410.2. The selective injection of light into the first injection element 420.1 and/or into the second injection element 420.2 thus allows projection of the first pattern, the second pattern, none of the patterns or both patterns at the same time, thus allowing, by dynamic control, an animation to be produced from at least the first and second patterns.

In the example of FIG. 4, the first and second patterns 416.1 and 416.2 have distinct shapes, and are identical to the patterns 316.1 and 316.2 of FIG. 3, for illustrative purposes. However, according to the definition of pattern provided above, the patterns may be any intentional, or predetermined, spatial distribution of luminous intensity. Furthermore, where the patterns are shapes, the first and second patterns 416.1 and 416.2 may have identical shapes but distinct colors. Indeed, the colors respectively projected for each pattern may vary, when the sources 430.1 and 430.2 produce light of different colors.

An example with two patterns, two injection elements and two flexible guide sheets has been shown in FIG. 4. However, the third embodiment also covers a luminous module with at least three flexible guide sheets with at least three injection elements, with each injection element being placed facing one of the flexible guide sheets, and one of the flexible guide sheets comprising the mesh 114. Dedicated sources for each injection element can be provided to this end, or a single source with several optical fibers can be provided to this end.

At least one of the flexible guide sheets may be transparent. As a variant, according to the third embodiment, the flexible guide sheet located below the luminous module 400, i.e., the first flexible guide sheet 410.1, can be opaque or semi-transparent. Conversely, the second flexible guide sheet 410.2 is transparent or semi-transparent, so as to allow through at least some of the light emitted by the first flexible guide sheet 410.2.

FIG. 5 illustrates a luminous module 500 according to a fourth embodiment of the invention.

In the fourth embodiment of the invention, the luminous module 500 comprises at least one first flexible guide sheet 510.1 and one second flexible guide sheet 510.2, with the two flexible guide sheets being placed next to one another, and the two flexible guide sheets are thus able to project light rays from distinct positions in the X-Y plane in which the flexible guide sheets mainly extend.

It should be noted that, due to their flexibility, the guide sheets may not be flat but may be curved. FIG. 5 thus shows the luminous module 500 when the flexible guide sheets are flat, for example, placed on a flat rigid support.

Thus, the first flexible guide sheet 510.1 is able to project a first pattern, not shown, at a first position on the X-Y plane, and the second flexible guide sheet 510.2 is able to project a second pattern 516.2 at a second position on the X-Y plane, with the first and second positions being distinct, for example, next to one another. Each projected pattern can include a symbol or a portion of a symbol. When a pattern of a flexible guide sheet includes a portion of a symbol, this portion can match another portion of a symbol formed by the pattern of another flexible guide sheet, or other portions of symbols formed by the patterns of other flexible guide sheets.

A first injection element 520.1 is arranged to inject light into an edge of the first flexible guide sheet 510.1 and a second injection element 520.2 is able and arranged to inject light into an edge of the second guide sheet 510.2.

The relative arrangement of the injection elements and of the flexible guide sheets is in accordance with the explanations set forth above, and is not described in detail again for the fourth embodiment of FIG. 5.

The first and second injection elements 520.1 and 520.2 can be similar to the injection element 120 described with reference to FIGS. 1a and 1b. Similarly, at least one of the flexible guide sheets 510.1 and 510.2 can correspond to the flexible guide sheet 110 described above. Preferably, only one of the flexible guide sheets 510.1 and 510.2 comprises a mesh 114 forming an antenna as described above, although it is not shown in FIG. 4. In this case, the other flexible guide sheets are similar to the flexible guide sheet 110 described above, except that they do not include a mesh 114.

A first source 530.1 is arranged facing an entry surface of the first injection element 520.1 so as to propagate light rays inside the first injection element 520.1 and therefore toward the first flexible guide sheet 510.1. A second source 530.2 is arranged facing an entry surface of the second injection element 520.2 so as to propagate light rays inside the second injection element 520.2 and therefore toward the second flexible guide sheet 510.2.

As a variant, a single source can be provided and the luminous module 500 comprises a first optical fiber able to convey light from the single source to the entry surface of the first injection element 520.1 and a second optical fiber is able to convey light from the single source to the entry surface of the second injection element 520.2.

The first and second sources 530.1 and 530.2, or the single source, can selectively inject light into the first injection element 520.1 and/or into the second injection element 520.2. Such selective injection can be controlled by a control element 540 connected to the two sources 530.1 and 530.2, or controlling the power supply to the two sources 530.1 and 530.2.

The first pattern is etched into the first flexible guide sheet 510.1, while the second pattern is etched into the second flexible guide sheet 510.2. The selective injection of light into the first injection element 520.1 and/or into the second injection element 520.2 thus allows projection of the first pattern, the second pattern, none of the patterns or both patterns at the same time, thus allowing, by dynamic control, an animation to be produced from at least the first and second patterns.

In the example of FIG. 5, a luminous module 500 comprising twelve flexible guide sheets, twelve injection elements and twelve light sources, arranged in a matrix with three rows and four columns, has been shown, purely for illustrative purposes.

No restriction is imposed on the number of flexible guide sheets in the third embodiment. The third embodiment thus applies to N flexible guide sheets, N respectively associated injection elements, and N luminous sources, or a single source connected by N optical fibers to the N injection elements, with N being any integer greater than or equal to 2.

In addition, no restriction is imposed on the arrangement of the flexible guide sheets relative to each other. When positioned as matrices, no restriction is imposed on the number of rows or the number of columns.

The first and second patterns can assume distinct shapes, and can be identical, for example, to the patterns 316.1 and 316.2 of FIG. 3. However, according to the definition of a pattern provided above, the patterns can be any spatial distribution of luminous intensity. Furthermore, when the patterns are shapes, the first and second patterns may have identical shapes but distinct colors. Indeed, the colors respectively projected for each pattern may vary, when the sources 530.1 and 530.2 produce light of different colors.

The flexible guide sheets can be connected to one another by a supporting matrix structure, which itself can be flexible. As a variant, each flexible guide sheet can be connected to the surrounding flexible guide sheets by fastening means, by bonding, clamping, clipping, or any other method.

The assembly of light sources can be controlled by the control element 540, via a set of wires, with each wire connecting the control element 540 to a light source. The wires can be supported by a structure 550 allowing the wires to be centralized and to be routed toward the control element, thus reducing the footprint, and also allowing the wires to be shielded.

No restriction is imposed on the dimensions of the flexible guide sheets in the X-Y plane. For example, each flexible guide sheet can be rectangular or square, with at least one dimension ranging between 2 and 10 cm. For example, the flexible guide sheets are squares or rectangles, with:
a dimension ranging between 2 cm and 10 cm, for example, between 2 cm and 5 cm, for example, equal to 5 cm; and
another dimension ranging between 2 cm and 10 cm, for example, between 2 cm and 5 cm, for example, equal to 5 cm.

For example, each flexible guide sheet is a 3 cm by 3 cm square.

The second, third and fourth embodiments have been described exclusively in relation to one another. However, it should be noted that these three embodiments can be combined in the same luminous module, in particular:
the second embodiment and the third embodiment can be combined: at least two flexible guide sheets are overlaid, and one of the two flexible guide sheets is associated with two light injection guides able to selectively inject light into two distinct portions of the guide sheet, with two patterns being respectively etched into the two portions, and one of the flexible guide sheets comprises a metal nanometric mesh 114 forming an antenna;
the second embodiment and the fourth embodiment can be combined: at least two flexible guide sheets are placed next to one another, and one of the two flexible guide sheets is associated with two light injection guides able to selectively inject light into two distinct portions of the guide sheet, with two patterns being respectively etched into the two portions, and one of the flexible guide sheets comprises a metal nanometric mesh 114 forming an antenna;
the third embodiment and the fourth embodiment can be combined: at least two flexible guide sheets are placed next to each other, and one of the two flexible guide sheets is overlaid with a third flexible guide sheet of the luminous module, and one of the flexible guide sheets comprises a metal nanometric mesh 114 forming an antenna;
the second embodiment, the third embodiment and the fourth embodiment can be combined: at least two flexible guide sheets are placed next to each other, and one of the two flexible guide sheets is overlaid with a third flexible guide sheet of the luminous module, and one of these three flexible guide sheets is associated with two light injection guides able to selectively inject light into two distinct portions of the guide sheet, with two patterns being respectively etched into the two portions, and one of the flexible guide sheets comprises a metal nanometric mesh 114 forming an antenna.

FIG. 6 illustrates a device 600 comprising a luminous module 100, 200, 300, 400, 500 according to any of the previously described embodiments.

No restriction is imposed on the device 600. Preferably, the device 600 is an external device for an automotive vehicle.

For example, the device 600 can be a front or rear lighting or signaling device for an automotive vehicle. It is thus possible to fulfill a light, signaling, telecommunication or esthetic function, at the same time as an antenna function, for a radar or telecommunications, for example, cellular, application.

In the case whereby the device 600 is a front lighting device for an automotive vehicle, the luminous module 100, 200, 300, 400, 500, can be arranged in front of a luminous module of the lighting device fulfilling a given function, and may be able to produce a light pattern assuming the shape of the luminous module, when this luminous module is turned off. It is thus possible to harmonize a light signature of the lighting device, whether or not the luminous module is switched on. Such harmonization notably can be permitted between daytime and nighttime periods.

As previously indicated, the metal nanometric mesh can repeat or amplify an electromagnetic wave so as to facilitate its detection by a sensor of the device 600 or of another device, not shown.

FIG. 7 is a diagram illustrating the steps of a method for manufacturing a luminous module according to one embodiment of the invention.

The manufacturing method comprises a step 700 of obtaining a roll of flexible film able to guide the light in the thickness thereof, such as the flexible film 111 described with reference to FIG. 1a. For example, the roll has at least one dimension of more than around ten centimeters, or even one meter. Preferably, the width of the roll is of the order of several tens of centimeters, or of one meter, and has a greater length, for example, greater than one meter. However, the thickness of the roll is low and equal to the thickness of the flexible film described above, so that several flexible guide sheets can be obtained by cutting the roll.

During a step 701, at least one pattern is etched onto the roll by ultraviolet printing. Microstructures, such as the microstructures 111 described above, are thus formed on the surface of the flexible film, with the microstructures being able to reflect the light guided in the flexible film toward the outside of the flexible film, notably in a direction substantially normal to the plane in which the flexible film extends when it is placed on a flat rigid support. The same pattern notably can be etched at regular intervals onto the roll of flexible film.

During a step 702, the roll is cut in order to obtain a flexible film with a given dimension, onto which the pattern is etched.

During a step 703, a metal nanometric mesh forming an antenna is obtained.

During a step 704, the metal nanometric mesh forming an antenna is arranged relative to the flexible film cut so as to form at least one flexible guide sheet. Several flexible guide sheets also can be obtained during step 704, with identical or different patterns, so as to be subsequently overlaid according to the third embodiment, or disposed next to each other according to the fourth embodiment.

During a step 705, at least one injection element is arranged relative to the assembly of at least one previously cut flexible guide sheet. As described above, several injection elements can be arranged relative to one or more flexible guide sheets, according to the second, third and fourth embodiments.

During a step 706, at least one light source is arranged so as to inject light into said at least one injection element. As described above, a light source can be dedicated to each injection element, in which case a light source is added to each assembly for the second and third embodiments, or, alternatively, a single light source is connected to the injection elements by respective optical fibers.

The step 703 of obtaining the metal nanometric mesh 114 can comprise, for example, the following sub-steps of:
during a step 710, obtaining a roll of substrate; [symbol] during a step 711, cutting a portion of the roll of substrate.

Preferably, the cut portion has the same dimensions as the flexible film cut during step 702;
during a step 712, the metal nanometric mesh 114 is produced on the cut portion of the substrate. For example, the metal nanometric mesh 114 can be produced using lithography, by placing a matching shaped mask on the cut portion of the substrate, and by etching the substrate with the metal of the metal nanometric mesh 114.

Thus, during step 704, the portion of the substrate cut with the mesh 114 is arranged on the flexible film, by rolling, for example, so as to form a protective layer for the flexible film, and thus produce the flexible guide sheet 110 as described with reference to FIG. 1a.

The present invention is not limited to the embodiments that have been described above by way of examples; it extends to other variants.

What is claimed is:

1. A luminous module comprising:
an assembly of at least one flexible guide sheet, with each flexible guide sheet of the assembly being able to receive light rays via at least one edge of the flexible guide sheet and to reflect the light rays in a direction substantially normal to a surface of the flexible guide sheet according to at least one pattern etched into the flexible guide sheet;
at least one light injection element able to receive light and to distribute the light in the assembly of at least one flexible guide sheet;
at least one light source able to inject light into the at least one light injection element; and
a metal nanometric mesh forming an antenna and arranged on at least one surface of at least one flexible guide sheet of the assembly.

2. The luminous module as claimed in claim 1, wherein the metal nanometric mesh includes metal strips that are less than 100 nanometers wide.

3. The luminous module as claimed in claim 1, further comprising a device connected to the metal nanometric mesh and able to transmit and/or receive radio frequency signals via the metal nanometric mesh.

4. (canceled)

5. (canceled)

6. The luminous module as claimed in claim 1, wherein each flexible guide sheet includes a flexible film with a pattern etched thereon, and at least one protective layer covering the flexible film, with the metal nanometric mesh being arranged on a surface of the protective layer of at least one flexible guide sheet.

7. The luminous module as claimed in claim 6, wherein the protective layer on which the metal nanometric mesh is arranged is arranged so as to be traversed by light rays emitted by the flexible film.

8. The luminous module as claimed in claim 7, wherein the metal nanometric mesh is arranged on an external surface of the protective layer, so that the protective layer is included between the flexible film and the metal nanometric mesh.

9. The luminous module as claimed in claim 1, wherein the at least one light injection element includes at least one first light injection element and one second light injection element, wherein the at least one light source is able to selectively inject light into the first light injection element and into the second light injection element, and at least one first pattern and one second pattern are etched into the assembly of at least one flexible guide sheet;
wherein the first light injection element and the assembly of at least one flexible guide sheet are arranged so as to project light according to the first pattern and wherein the second light injection element and the assembly of at least one flexible guide sheet are arranged so as to project light according to the second pattern.

10. The luminous module as claimed in claim 9, wherein the at least one light source includes a first light source able to inject light into the first light injection element and a second light source able to inject light into the second light injection element.

11. The luminous module as claimed in claim 9, wherein the first injection element is arranged so as to inject light into a first section of the edge of the guide sheet of the assembly, and wherein the second injection element is arranged so as to inject light into a second section of the edge of the flexible guide sheet, with a first portion of the flexible guide sheet located facing the first section of the edge being etched according to the first pattern, and a second portion of the flexible guide sheet located facing the second section of the edge being etched according to the second pattern.

12. The luminous module as claimed in claim 9, wherein the at least one flexible guide sheet includes at least a first and a second flexible guide sheet, the first pattern being etched into the first flexible guide sheet and the second pattern being etched into the second flexible guide sheet, the first injection element being arranged so as to inject light into an edge of the first flexible guide sheet and the second injection element being arranged so as to inject light into an edge of the second flexible guide sheet.

13. The luminous module as claimed in claim 12, wherein the first and second guide sheets are overlaid in the luminous module, in order to project the first and second patterns into a common area of the luminous module.

14. The luminous module as claimed in claim 12, wherein the first and second flexible guide sheets are placed next to one another so as to project the first and second patterns at distinct positions.

15. The module as claimed in claim 1, further comprising a control element able to control the at least one source in order to selectively project light according to the at least one pattern.

16. (canceled)

17. The module as claimed in claim 1, wherein each flexible guide sheet includes a film including microstructures, in which each pattern from among the first and second patterns is etched by ultraviolet printing the microstructures of the film.

18. An external device for an automotive vehicle, comprising a luminous module, the luminous module includes an assembly of at least one flexible guide sheet, with each flexible guide sheet of the assembly being able to receive light rays via at least one edge of the flexible guide sheet and to reflect the light rays in a direction substantially normal to a surface of the flexible guide sheet according to at least one pattern etched into the flexible guide sheet, at least one light injection element able to receive light and to distribute the light in the assembly of at least one flexible guide sheet, at least one light source able to inject light into the at least one light injection element, and a metal nanometric mesh forming an antenna and arranged on at least one surface of at least one flexible guide sheet of the assembly.

19. The external device as claimed in claim 18, the device being a front lighting device for an automotive vehicle.

20. The external device as claimed in claim 18, further comprising a sensor able to detect a signal from an electromagnetic wave repeated or amplified by the metal nanometric mesh.

21. A method for manufacturing a luminous module comprising:
providing a roll of flexible film able to guide light in the thickness thereof;
etching at least one pattern onto the roll of flexible film using ultra-violet printing;
cutting the roll in order to obtain at least one flexible film with a given dimension, the flexible film including the etched pattern;
obtaining a metal nanometric mesh forming an antenna;
arranging the metal nanometric mesh on the flexible film so as to form an assembly of at least one flexible guide sheet;
arranging at least one injection element relative to the assembly of at least one flexible guide sheet in order to form a luminous module;
arranging at least one light source in the luminous module so as to inject light into the at least one light injection element.

22. The method as claimed in claim 21, wherein obtaining the metal nanometric mesh forming an antenna includes:
providing a roll of substrate;
cutting a portion of the roll of substrate;
producing the metal nanometric mesh on the cut portion or on the roll of substrate before cutting the portion;
wherein the metal nanometric mesh is arranged on the flexible film by depositing the cut portion with the metal nanometric mesh in order to form a protective layer for the etched flexible film.

23. The method as claimed in claim 22, wherein the metal nanometric mesh is produced on the cut portion by lithography by placing a mask matching the mesh on the cut portion of the roll.
